(19) United States
(12) Patent Application Publication
(10) Pub. No.: US 2020/0183254 A1
(43) Pub. Date: Jun. 11, 2020

(54) CAMERA MODULE

(71) Applicant: TRIPLE WIN TECHNOLOGY(SHENZHEN) CO.LTD., Shenzhen (CN)

(72) Inventors: XIAO-MEI MA, Shenzhen (CN); SHIN-WEN CHEN, Tu-Cheng (TW); LONG-FEI ZHANG, Shenzhen (CN); KUN LI, Shenzhen (CN)

(21) Appl. No.: 16/249,008

(22) Filed: Jan. 16, 2019

(30) Foreign Application Priority Data
Dec. 5, 2018 (CN) 201811482147.3

(51) Int. Cl. G03B 17/12

(52) U.S. Cl. CPC G03B 17/12; G03B 11/00

(57) ABSTRACT

A camera module includes a circuit board, an image sensor, a lens holder, and a lens. The image sensor is arranged on the circuit board. The lens holder is covered over the image sensor. The lens is arranged on the lens holder. The lens holder is adhered to the circuit board by a colloid. The lens holder includes a projection on a side of the lens holder facing the circuit board. The projection is embedded within the colloid.

### FIELD

The subject matter herein generally relates to a camera module.

### BACKGROUND

With emphasis on information security, many systems (such as access control systems) or terminals (such as mobile phones) are equipped with face recognition functions.

A camera module generally includes a circuit board, an image sensor on the circuit board, a lens holder on the image sensor, and a lens received in the lens holder. A bottom of the lens holder is generally bonded to the circuit board by a gel. When the camera module captures an image, light generated by external light-emitting parts easily passes through a connection between the lens holder and the colloid, thereby affecting the image sensor and a clarity of the captured image. In addition, when the camera module is impacted by an external force, the colloid may be deformed or cracked, and the lens holder may become detached.

### BRIEF DESCRIPTION OF THE DRAWINGS

Implementations of the present disclosure will now be described, by way of embodiments, with reference to the attached figures.

FIG. 1 is an isometric view of an embodiment of a camera module.

FIG. 2 is an exploded view of the camera module in FIG. 1.

FIG. 3 is similar to FIG. 2, but showing the camera module from another angle.

FIG. 4 is a cross-sectional view of the camera module in FIG. 1 taken along line IV-IV.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

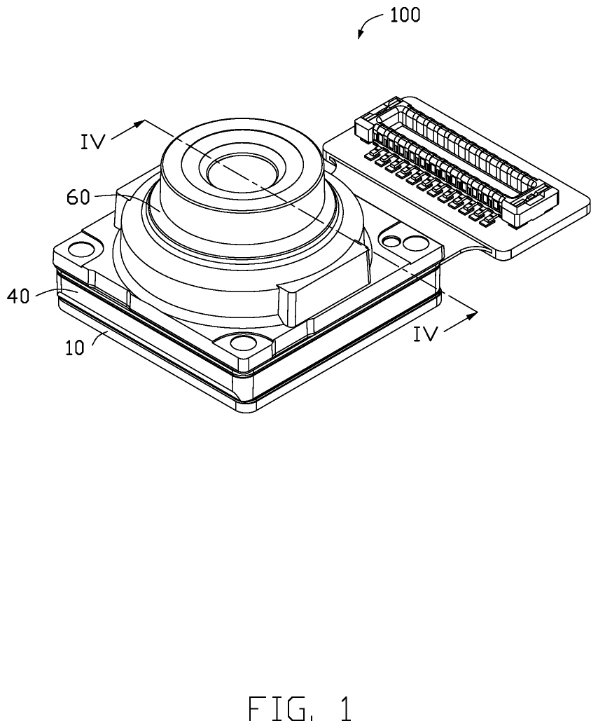

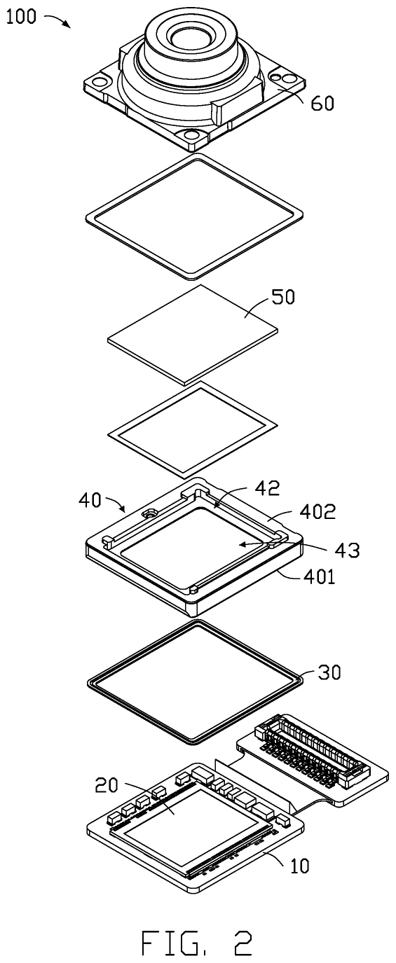

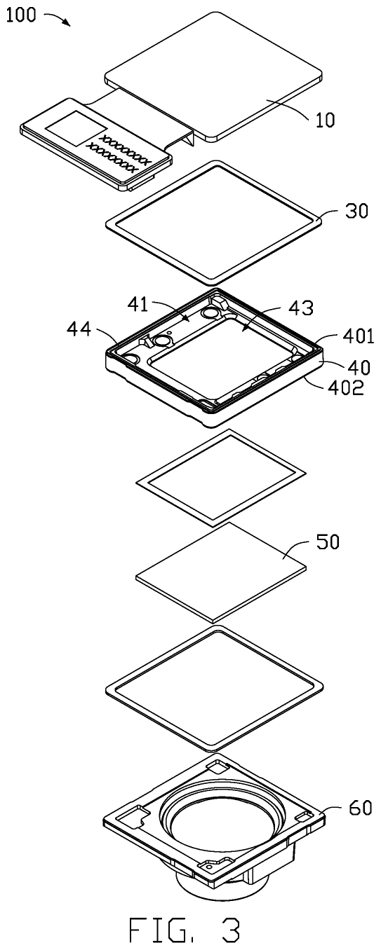

FIGS. 1-3 show a camera module 100 including a circuit board 10, an image sensor 20, a colloid 30, a lens holder 40, a filter 50, and a lens 60.

In one embodiment, the circuit board 10 is a flexible circuit board, but is not limited thereto.

The image sensor 20 is arranged on the circuit board 10. The lens holder 40 is adhered to the circuit board 10 by the colloid 30 and covers the image sensor 20.

The lens holder 40 is substantially rectangular. The lens holder 40 includes a first surface 401 facing one side of the circuit board 10 and a second surface 402 facing away from the circuit board 10.

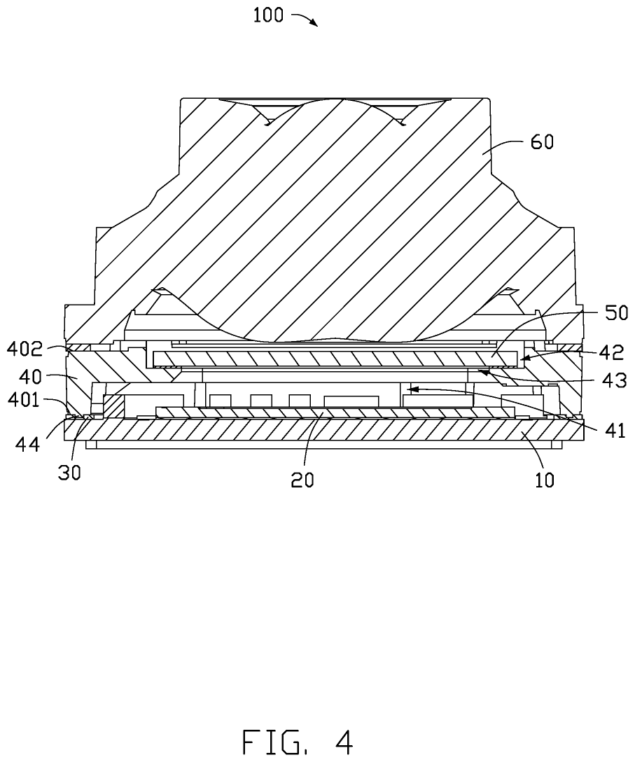

As shown in FIG. 4, the first surface 401 is recessed toward the second surface 402 to form a first receiving cavity 41, and the second surface 402 is recessed toward the first surface 401 to form a second receiving cavity 42. The first receiving cavity 41 and the second receiving cavity 42 are connected by a conducting hole 43. A diameter of the conducting hole 43 is less than a diameter of the first receiving cavity 41 and the second receiving cavity 42. The conducting hole 43 allows light to enter therethrough. The image sensor 20 is received in the first receiving cavity 41.

The first surface 401 includes a projection 44 surrounding the first receiving cavity 41.

The colloid 30 is applied on the circuit board 10 surrounding the image sensor 20 and is substantially hollow rectangular. The colloid 30 adheres the circuit board 10 and the lens holder 40 together. A hole is defined in a middle portion of the colloid 30. The first surface 401 is adhered to the colloid 30, and the projection 44 is embedded within the colloid 30.

The projection 44 is an annular structure surrounding the first receiving cavity 41. In one embodiment, the projection 44 is substantially a square frame, but is not limited thereto. In other embodiments, the projection 44 may be different shapes as needed, as long as it can embed within the colloid 30.

In one embodiment, a surface of the projection 44 is a flat, but is not limited thereto. In other embodiments, the surface of the projection 44 may be configured to have an undulating structure such as stripe-shaped or ripple-shaped to improve a bonding force with the colloid 30.

In one embodiment, a cross-section of the projection 44 along a direction passing through the first receiving cavity 41 (or the image sensor 20) is a rectangle, but is not limited thereto. In other embodiments, the cross-section of the projection 44 along the direction passing through the first receiving cavity 41 (or the image sensor 20) may also be prism-shaped.

The filter 50 is received within the second receiving cavity 42 for filtering infrared light.

The lens 60 is mounted to a side of the lens holder 40 facing away from the circuit board 10. In one embodiment, the lens 60 is mounted to the lens holder 40 by screws, but is not limited thereto.

In other embodiments, the camera module 100 can also be a dual camera module, such that the first surface 401 of the lens holder 40 includes two first receiving cavities 41, the second surface 402 includes two second receiving cavities 42, each of the first receiving cavities 41 is connected to a corresponding one of the second receiving cavities 42 through a conducting hole 43, each of the two first receiving cavities 41 receives an image sensor 20, and the projection 44 surrounds an outer side of the two first receiving cavities 41.

The camera module 100 is assembled by first adhering the image sensor 20 to the circuit board 10 by the colloid 30, and then applying the colloid 30 around the image sensor 20 on the circuit board 10. Next, the lens holder 40 is pressed against the colloid 30 to embed the projection 44 within the colloid 30. Then, the filter 50 is adhered within the second receiving cavity 42 through another adhesive layer. Finally, the lens 60 is mounted to the lens holder 40 (such as by screwing) to complete the assembly.

The camera module 100 includes the projection 44 on the lens holder 40, and the projection 44 is embedded within the colloid 30. The projection 44 can block external light from entering the first receiving cavity 41, thereby enhancing image quality. In addition, the projection 44 increases a contact area between the lens holder 40 and the colloid 30, and the embedded bonding can improve a bonding strength of the camera module 100.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A camera module comprising:
a circuit board;
an image sensor arranged on the circuit board;
a lens holder covered over the image sensor;
a lens arranged on the lens holder; wherein:
the lens holder is adhered to the circuit board by a colloid;
the lens holder comprises a projection on a side of the lens holder facing the circuit board;
the projection is embedded within the colloid.

2. The camera module of claim 1 further comprising a filter, wherein:
the lens holder comprises a first receiving cavity, a second receiving cavity, and a conducting hole;
the first receiving cavity is on a side of the lens holder facing the circuit board;
the second receiving cavity is on a side of the lens holder facing away from the circuit board;
the conducting hole connects the first receiving cavity to the second receiving cavity;
the image sensor is received within the first receiving cavity;
the filter is received within the second receiving cavity.

3. The camera module of claim 2, wherein the projection is an annular structure surrounding the first receiving cavity.

4. The camera module of claim 1, wherein a surface of the projection is flat.

5. The camera module of claim 1, wherein a surface of the projection is stripe-shaped or ripple-shaped.

6. The camera module of claim 1, wherein a cross-section of the projection along a direction of the image sensor is rectangular.

7. The camera module of claim 1, wherein a cross-section of the projection along a direction of the image sensor is prism-shaped.

8. The camera module of claim 1, wherein:
the lens holder comprises two first receiving cavities on a side of the lens holder facing the circuit board;
each of the two first receiving cavities receives a corresponding image sensor;
the projection surrounds an outer side of the two first receiving cavities.

9. The camera module of claim 8, wherein:
the lens holder comprises two second receiving cavities on a side of the lens holder facing away from the circuit board; and
each of the second receiving cavities is connected to a corresponding one of the first receiving cavities by a conducting hole.
